(19) United States
(12) Patent Application Publication
(10) Pub. No.: US 2024/0072382 A1
(43) Pub. Date: Feb. 29, 2024

(54) BATTERY MODULE FOR MODULAR HIGH-VOLTAGE BATTERY SYSTEM

(71) Applicant: Atleva, Inc., Newark, CA (US)

(72) Inventors: James Hawkins, Fremont, CA (US); Harrison Senor, Newark, CA (US); Pablo Ramaswamy, Newark, CA (US); David Pui-Yin Tse, San Jose, CA (US)

(21) Appl. No.: 18/348,756

(22) Filed: Jul. 7, 2023

Related U.S. Application Data
(60) Provisional application No. 63/373,914, filed on Aug. 30, 2022.

(51) Int. Cl. H01M 50/514; H01M 50/209; H01M 50/24; H01M 50/249; H01M 50/503; H01M 50/507

(52) U.S. Cl. CPC H01M 50/514; H01M 50/209; H01M 50/24; H01M 50/249; H01M 50/503; H01M 50/507; B60L 50/64; H01M 2220/20

(57) ABSTRACT

A battery module for a modular high-voltage battery system comprises: electrochemical cells; a housing of an electrically insulating material, the housing enclosing the electrochemical cells; and a first connector at an outside surface of the housing, the first connector electrically connected to the electrochemical cells, the first connector comprising an insulating cover and a terminal accessible only through an opening in the insulating cover, the first connector configured for mating with a first electrical interconnect having a busbar to extend into the opening and contact the terminal.

### TECHNICAL FIELD

This application claims benefit, under 35 U.S.C. § 119, of U.S. Provisional Patent Application No. 63/373,914, filed on Aug. 30, 2022, entitled “BATTERY MODULE FOR MODULAR HIGH-VOLTAGE BATTERY SYSTEM”, the disclosure of which is incorporated by reference herein in its entirety.

### TECHNICAL FIELD

This document relates to a battery module for a modular high-voltage battery system.

### BACKGROUND

In recent years, the world's transportation has begun a transition away from powertrains primarily driven by fossil fuels and toward more sustainable energy sources. The majority of such increasingly prevalent powertrains include electric motors powered by on-board energy storages. In order to make these new modes of transportation available to larger segments of population, vehicle makers are striving to reduce the cost of manufacturing, assembling, operating and servicing electric vehicles.

Some existing battery packs of electric vehicles have modules of cells where the modules are electrically coupled to each other by bolted joints. This approach is associated with costs and time expense during manufacture and service. Moreover, disassembling the pack (e.g., removing a module) requires the service technician to have extensive high-voltage safety training and to use special high-voltage equipment.

### SUMMARY

In a first aspect, a battery module for a modular high-voltage battery system comprises: electrochemical cells; a housing of an electrically insulating material, the housing enclosing the electrochemical cells; and a first connector at an outside surface of the housing, the first connector electrically connected to the electrochemical cells, the first connector comprising an insulating cover and a terminal accessible only through an opening in the insulating cover, the first connector configured for mating with a first electrical interconnect having a busbar to extend into the opening and contact the terminal.

Implementations can include any or all of the following features. The battery module qualifies for an ingress protection rating according to International Electrotechnical Commission (IEC) standard IEC 60529 regarding solid particle protection of 2 or higher. The first connector protects against fingers or other objects not greater than about 80 mm in length. The first connector protects against fingers or other objects greater than about 12 mm in diameter. The opening is substantially a planar rectangle. The opening comprises a gap between first and second members, the first and second members joined to each other at a first end and separate from each other at a second end opposite the first end, wherein the terminal is positioned between the first and second members at the first end. The gap is substantially U-shaped. The battery module has substantially a rectilinear shape. The rectilinear shape comprises first and second main surfaces that are parallel to each other, and four side surfaces that are perpendicular to the first and second main surfaces, wherein each of the side surfaces abuts respective edges of the first and second main surfaces. The first connector is positioned on at least a first side surface of the side surfaces. The first side surface is smaller than a second side surface of the side surfaces. The battery module further comprises a second connector configured for mating with a second electrical interconnect, the second connector positioned at the outside surface of the housing on a second side surface of the side surfaces, the second side surface opposite to the first side surface. The opening faces along the first side surface. The battery module is configured for being installed side by side with other battery modules with the first side surface of the battery module and corresponding side surfaces of the other battery modules facing in a common direction with each other. At least the first main surface covers a current collector coupled to at least some of the electrochemical cells. The first connector is configured for mating with the first electrical interconnect where the busbar is a blade to extend into the opening.

In a second aspect, a modular high-voltage battery system comprises: first and second battery modules, each of the first and second battery modules comprising: electrochemical cells; a housing of a first electrically insulating material, the housing enclosing the electrochemical cells; and a connector at an outside surface of the housing, the connector electrically connected to the electrochemical cells, the connector comprising an insulating cover and a terminal accessible only through an opening in the insulating cover; and an electrical interconnect connecting the first and second modules to each other, the electrical interconnect comprising: a busbar configured for extending into each of the openings of the connectors of the first and second modules and contact the terminals of the connectors of the first and second modules; and a second insulating material partially covering the busbar.

### BRIEF DESCRIPTION OF DRAWINGS

FIG. 1 shows an example of an electric vehicle having a modular high-voltage battery system.

FIG. 2 shows an example of battery modules of electrochemical cells for a modular high-voltage battery system.

FIGS. 3A-3D show examples of a battery module.

FIGS. 4A-4B show examples of another battery module.

Like reference symbols in the various drawings indicate like elements.

### DETAILED DESCRIPTION

This document describes examples of systems and techniques for battery modules for holding electrochemical cells in a high-voltage battery system. Such a high-voltage battery system can be used in a vehicle and/or in a stationary power supply. The battery modules can be configured for breaking down a high voltage of the system into smaller chunks. This can enable safe servicing of individual modules to be performed in a service center without specialist high-voltage equipment or training. Previous connection approaches such as bolted joints are eliminated, which can help in qualifying the battery module for a favorable ingress protection rating. Providing a battery module with an interconnect interface according to the present disclosure can provide low contact resistance, enable ease of serviceability, and eliminate the need to torque bolts and the tracking and documentation associated with these operations. As such, the battery modules can enhance the high-voltage safety architecture.

Examples herein refer to a battery system, which is an assembly of electrochemical cells. A battery system can be configured to power an electric motor for propulsion, or to provide a stationary power supply, to name just two examples. Examples herein refer to a battery module, which is an individual component configured for holding and managing multiple electrochemical cells during charging, storage, and use. A battery system can include any number of modules. The battery module can be intended as the sole power source for one or more loads (e.g., electric motors), or more than one battery module of the same or different type can be used. A battery system can include two or more battery modules of the same or different type. A battery module can include control circuitry for managing the charging, storage, and/or use of electrical energy in the electrochemical cells, or the battery module can be controlled by an external component. For example, a battery management system can be implemented on one or more circuit boards (e.g., a printed circuit board).

Examples herein refer to a battery system having high voltage, sometimes referred to as a high-voltage battery system. Having high voltage involves an operating voltage or difference in potential that is generally considered lethal if contacted by humans. High voltage as used herein means at least about 250 volt (V). Voltages specified herein are direct current (DC) voltages. In some implementations, a high voltage battery system can have a voltage of more than about 300 V. In some implementations, a high voltage battery system can have a voltage of more than about 400 V. In some implementations, a high voltage battery system can have a voltage of more than about 500 V. In some implementations, a high voltage battery system can have a voltage of more than about 600V. In some implementations, a high voltage battery system can have a voltage of more than about 700 V. In some implementations, a high voltage battery system can have a voltage of more than about 800V. In some implementations, a high voltage battery system can have a voltage of more than about 900 V. By contrast, a battery terminal or other conductive element that is considered acceptable also for service personnel without special high voltage tools or high voltage training can be referred to as having a non-lethal voltage. For example, making a high voltage battery system (e.g., one having a voltage of more than about 900 V) serviceable without special high voltage tools or high voltage training can involve ensuring that high voltage terminals are not exposed to service personnel, and that only terminals of a non-lethal voltage are exposed, to the service personnel.

Examples herein refer to electrochemical cells. An electrochemical cell can include an electrolyte and two electrodes to store energy and deliver it when used. In some implementations, the electrochemical cell can be a rechargeable cell. For example, the electrochemical cell can be a lithium-ion cell. In some implementations, the electrochemical cell can act as a galvanic cell when being discharged, and as an electrolytic cell when being charged. The electrochemical cell can have at least one terminal for each of the electrodes. The terminals, or at least a portion thereof, can be positioned at one end of the electrochemical cell. For example, when the electrochemical cell has a cylindrical shape, one of the terminals can be provided in the center of the end of the cell, and the can that forms the cylinder can constitute the other terminal and therefore be present at the end as well. Other shapes of electrochemical cells can be used, including, but not limited to, prismatic shapes.

Examples described herein refer to a top, bottom, front, or rear. These and similar expressions identify things or aspects in a relative way based on an express or arbitrary notion of perspective. That is, these terms are illustrative only, used for purposes of explanation, and do not necessarily indicate the only possible position, direction, and so on.

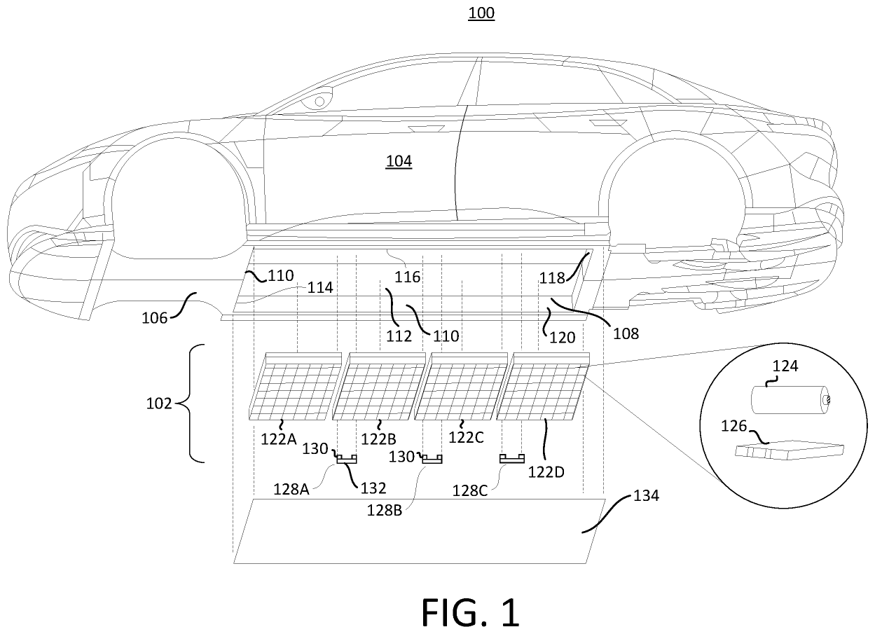

FIG. 1 shows an example of an electric vehicle (EV) 100 having a high-voltage (HV) battery system 102. The EV 100 is shown in an exploded view for illustrative purposes. The EV 100 and/or the HV battery system 102 can be used with one or more other examples described elsewhere herein. The EV 100 has one or more electric traction motors (not shown) to be powered by the HV battery system 102. Some other components of the EV 100 (including, but not limited to, wheels) are omitted in this illustration for clarity.

The EV 100 includes a vehicle body 104. The vehicle body 104 can include various structural components that together make up the framework and the multiple sections of the EV 100. In some implementations, the EV 100 includes a frame that is assembled from a number of individual sections. In some implementations, the EV 100 includes a chassis 106. For example, the chassis 106 can form the supporting structure for the vehicle body 104 and can be made using various frame components, rails, rockers, torque boxes, and/or cross-members.

The EV 100 has a cavity 108 in the vehicle body 104. The cavity 108 is here in part defined by an opening 110. The cavity 108 can be formed in any of various sections or portions of the vehicle body 104. In some implementations, the cavity 108 is formed in the chassis 106 of the vehicle body 104. For example, the cavity 108 can be configured so that the opening 110 faces toward ground on which the EV 100 is positioned.

The cavity 108 can have any shape, including, but not limited to, a rectilinear shape. In some implementations, the cavity is formed by a number of walls of the vehicle body 104. For example, the cavity 108 can at least in part be formed by a rear wall 112. As another example, the cavity 108 can at least in part be formed by a side wall 114 (obscured in the present illustration). As another example, the cavity 108 can at least in part be formed by a side wall 116 (obscured in the present illustration). As another example, the cavity 108 can at least in part be formed by a side wall 118. As another example, the cavity 108 can at least in part be formed by a side wall 120. The rear wall 112 can face (e.g., be substantially parallel with) the opening 110. One or more of the side walls 114-120 can be substantially perpendicular to the rear wall 112. The cavity 108 can have other shapes.

The HV battery system 102 can include multiple modules of electrochemical cells, sometimes referred to as battery modules or battery cell collectors because each of them serves to contain multiple electrochemical cells. Here, the HV battery system 102 includes modules 122A-122D of electrochemical cells. The modules 122A-122D are components that comprise the HV battery system 102. The modules 122A-122D can be positioned in any arrangement within the cavity 108. Each of the modules 122A-122D can be an individual unit that can be manufactured separately and installed in the cavity 108. For example, each of the modules 122A-122D can be mounted to (e.g., abutting) the rear wall 112. The HV battery system 102 may or may not have a standalone pack enclosure (not shown).

Each of the modules 122A-122D includes multiple electrochemical cells. The electrochemical cells can have one or more of multiple form factors. In some implementations, the HV battery system 102 can use an electrochemical cell 124 having a cylinder shape. In some implementations, the HV battery system 102 can use an electrochemical cell 126 having a prismatic shape. Other form factors can be used.

The HV battery system 102 can include electrical interconnects to couple the modules 122A-122D to each other and/or to other electrical fittings within the cavity 108. Here, the HV battery system 102 includes electrical interconnects 128A-128C. The electrical interconnects 128A-128C are components that comprise the HV battery system 102. The electrical interconnects 128A-128C can serve one or more of multiple purposes. For example, the electrical interconnects 128A-128C can connect two or more of the modules 122A-122D to each other and thereby increase the overall voltage from a module-level voltage (e.g., a non-lethal voltage) to a battery system-level voltage (e.g., a lethal voltage). As another example, one or more of the electrical interconnects 128A-128C can be selectively removed (e.g., for a service session) so as to reduce the overall voltage from the battery system-level voltage to the module-level voltage.

Each of the electrical interconnects 128A-128C can include a busbar that is partially covered by insulation. For example, the electrical interconnect 128A includes a busbar that provides terminals 130, and also includes insulation 132 that covers the busbar. The terminal(s) 130 can have any shape. In some implementations, the terminal 130 is a blade formed of the busbar. In some implementations, the electrical interconnect 128A can electrically connect the modules 122A-122B to each other. In some implementations, the electrical interconnect 128B can electrically connect the modules 122B-122C to each other. In some implementations, the electrical interconnect 128C can electrically connect the modules 122C-122D to each other.

The EV 100 includes a closure 134 that is configured for closing the opening 110 of the cavity 108. The closure 134 can include a member of metal and/or composite material. In some implementations, the closure 134 is in form of a sheet of material serving as a shield for the cavity 108. Other shapes can be used for the closure 134.

Having the modules 122A-122D that are selectively connected or disconnected by way of the electrical interconnects 128A-128C can provide advantages relating to serviceability of the EV 100. For example, after removal of the closure 134, with the electrical interconnects 128A-128C remaining installed in their respective places, no high voltage terminal of the HV battery system 102 is exposed to the technician. That is, high voltage terminals of the modules 122A-122D may then be covered (e.g., by insulating material of the electrical interconnects 128A-128C) so as to make the individual modules 122A-122D, and the HV battery system 102 as a whole, finger safe. For example, the insulation of the electrical interconnects 128A-128C serves to cover, and thereby prevent inadvertent contact with, high voltage terminals or other conductors. Service personnel can then remove one or more of the electrical interconnects 128A-128C. Any of multiple ways of removal can be used. In some implementations, the electrical interconnects 128A-128C can be removed by way of grasping the insulated portion of, and pulling on, the respective electrical interconnect 128A-128C.

Removal of the electrical interconnect severs the electrical connection between the corresponding ones of the modules 122A-122D and thereby reduces the voltage from a system voltage level (e.g., a lethal voltage) to a module-level voltage (e.g., a non-lethal voltage). The present subject matter can make the HV battery system 102 finger safe in that it allows the HV battery system 102 to be serviced without special high voltage tools or high voltage training. That is, the HV battery system 102 is disconnected to be a fraction of the complete battery system voltage before any of the modules 122A-122D can be accessed for service. For example, each of the modules 122A-122D has a voltage lower than the voltage of the HV battery system 102.

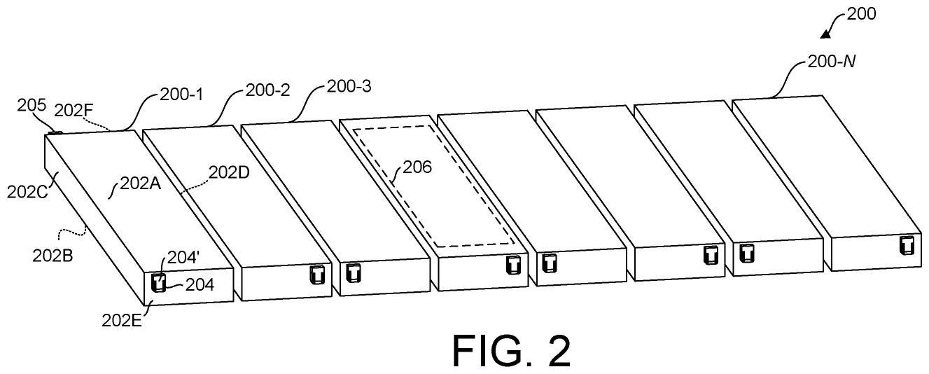

FIG. 2 shows an example of battery modules 200 of electrochemical cells for a modular high-voltage battery system. The battery modules 200 can be used with one or more other examples described elsewhere herein. Any number of battery modules can be included. Here, battery modules 200-1, 200-2, 200-3, . . . , 200-N are indicated, where N is any integer. The battery modules 200 can be placed in any configuration relative to each other. For example, here the battery modules 200 are arranged in a row where each of the battery modules 200 sits adjacent one or two others of the battery modules 200. Each of the battery modules 200 encloses multiple electrochemical cells (not shown). For example, each of the battery modules 200 can have the same number of electrochemical cells. Other approaches can be used.

Each of the battery modules 200 can have substantially a rectilinear shape. For example, each surface of any of the battery modules 200 can be substantially planar and rectangular. In some implementations, each of the battery modules 200 has a main surface 202A, as here shown with the battery module 200-1. The battery module 200-1 can have a main surface 202B (here obscured) that is parallel to the main surface 202A. The battery module 200-1 can have a side surface 202C. The battery module 200-1 can have a side surface 202D (here obscured) that is parallel to the side surface 202C. The battery module 200-1 can have a side surface 202E. The battery module 200-1 can have a side surface 202F (here obscured) that is parallel to the side surface 202E. That is, the battery module 200-1 can have four side surfaces, the side surfaces 202C-202F, that are perpendicular to the main surfaces 202A-202B and that abut respective edges of the main surfaces 202A-202B.

Each of the battery modules 200 can include a housing of an electrically insulating material. In some implementations, the battery modules 200 can be molded. For example, molding can be performed using a polymer material such as a thermoplastic or thermosetting substance. One or more other materials can be added to the polymer material before the molding to change one or more of its properties. In some implementations, a polycarbonate material can have one or more additives. For example, strands of glass and/or another material can be added.

Each of the battery modules 200 can have at least one connector 204 at an outside surface, as here shown with the battery module 200-1. The connector(s) 204 can provide the high voltage connection(s) to the battery module 200-1, and can also allow the modular high-voltage battery system to be broken down into units of lesser voltage, for service or maintenance. The connector 204 is electrically connected to the electrochemical cells of the battery module 200-1. For example, the connector 204 is connected to one or more busbars (not shown) inside the battery module 200-1 and thereby to the electrochemical cells of the battery module 200-1. The connector 204 is configured for mating with an electrical interconnect (e.g., any of the electrical interconnects 128A-128C in FIG. 1). The connector 204 has an insulating cover 204′ and a terminal accessible only through an opening in the insulating cover 204′. As such, the connector 204 can provide the battery module 200-1 with an advantageous ingress protection rating, such as to make it finger safe.

One or more instances of the connector 204 can be positioned on the outside of any or all of the battery modules 200. In some implementations, the connector 204 is placed on the side surface 202E and/or 202F. For example, the connector 204 can be placed on one of the side surfaces 202C-202F that is smaller than another of the side surfaces 202C-202F. The connector can be placed at any location on any of the external surfaces. In some implementations, the connector 204 is placed centrally, or in an off-center position, on the surface. For example, the connector 204 can be positioned closer to a corner of the battery module 200, wherein that corner is near the location of a corresponding connector on the adjacent battery module (e.g., as illustrated with the modules 200-2 and 200-3). In some implementations, the battery module 200-1 has a connector 205 positioned on the side surface 202F. That is, the connector 205 can be configured for mating with another electrical interconnect (e.g., identical to the electrical interconnect for the connector 204), the connector 205 positioned at the outside surface of the housing side surface 202F, which is opposite to the side surface 202E.

The battery modules 200 can be configured for being installed side by side with each other. In some implementations, the battery module 200-1 can have one of its side surfaces 202C-202F facing toward a side surface of an adjacent one of the battery modules 200. For example, the battery module 200-1 can have the side surface 202D facing directly toward a corresponding side surface of the battery module 200-2. As such, the side surfaces 202E, for example, of the battery modules 200 can face in a common direction with each other.

Each of the battery modules 200 can have a current collector 206 (here obscured, and schematically illustrated as a rectangle) coupled to at least some of the electrochemical cells. The current collector 206 can include a busbar or any other conductive substrate that is coupled to at least some of the electrochemical cells. In some implementations, the main surface 202A and/or 202B covers the current collector 206.

In a method of manufacturing a modular high-voltage battery system, the battery modules 200-2 and 200-3 can be installed adjacent each other (e.g., in the EV 100 of FIG. 1). An electrical interconnect (e.g., any of the electrical interconnects 128A-128C in FIG. 1) can be mounted to the battery modules 200-2 and 200-3. For example, this can involve relative sliding between on the one hand the safety interconnect and on the other hand the battery modules 200-2 and 200-3.

In a method of servicing a modular high-voltage battery system, a service technician can access an installation of a modular high-voltage battery system (e.g., in the EV 100 of FIG. 1). The service technician can remove the safety interconnect mounted to the battery modules 200-2 and 200-3 (e.g., by pulling or pushing). This reduces the voltage of the battery system to a non-lethal level. When service is completed, the service technician can subsequently mount the safety interconnect to the battery modules. The removal of the safety interconnect can be done whenever the modular high-voltage battery system is subject to service.

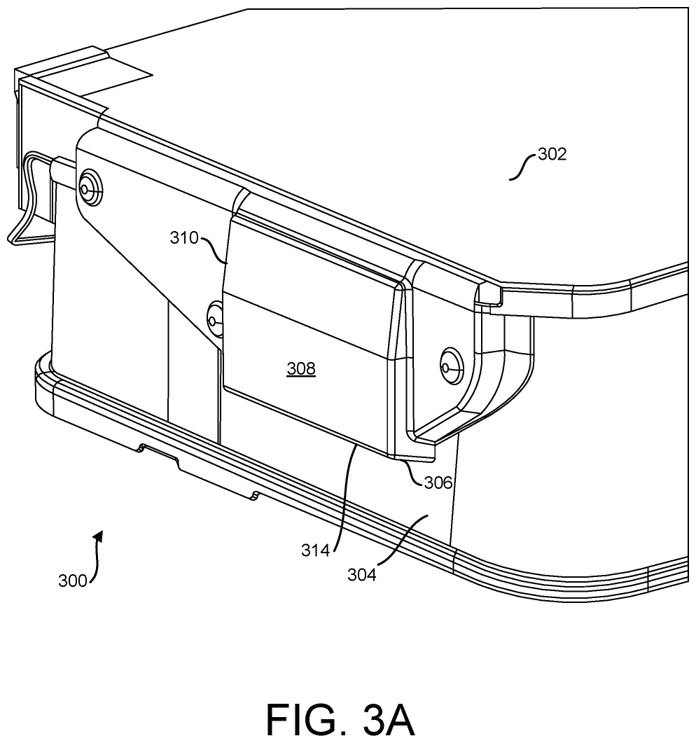

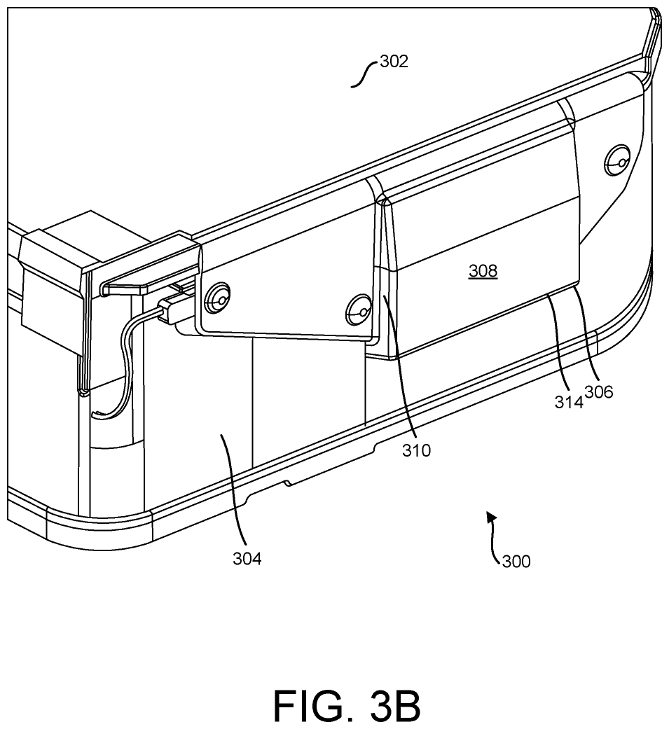

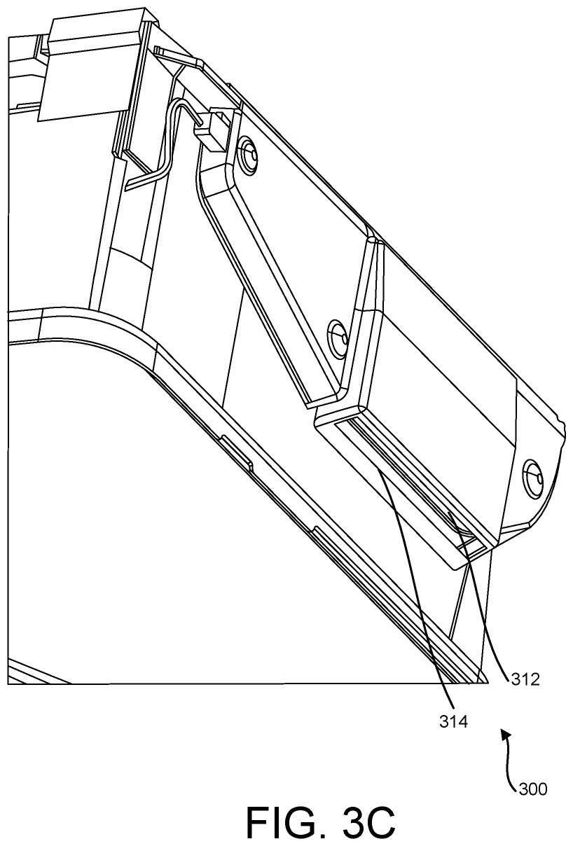

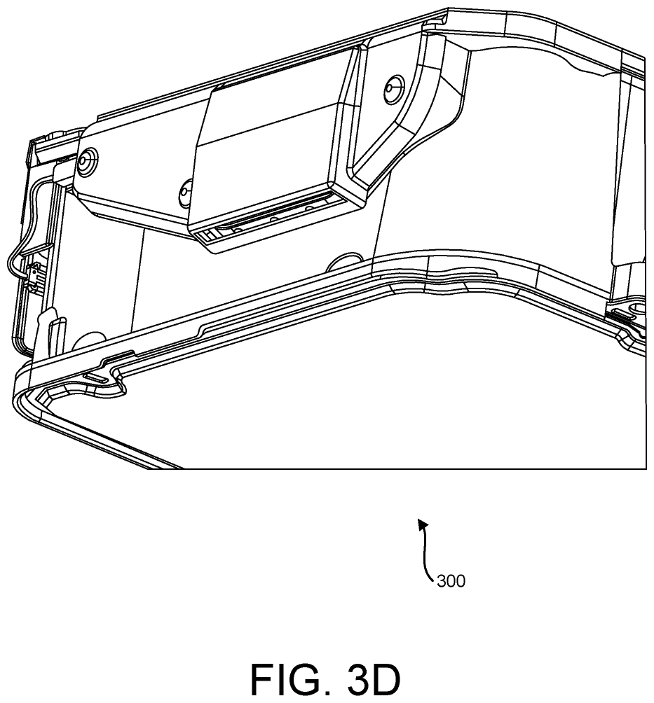

FIGS. 3A-3D show examples of a battery module 300. The battery module 300 can be part of a modular high-voltage battery system and can be used with one or more other examples described elsewhere herein. The battery module 300 includes a housing of an insulating material and encloses electrochemical cells. Here, a main surface 302 and a side surface 304 are shown. The battery module 300 has a connector 306 on the side surface 304. The connector 306 is electrically connected to the electrochemical cells. The connector 306 comprises an insulating cover 308 that includes one or more insulated portions 310. For example, the insulating cover 308 can be made from the same material as the housing of the battery module 300. The connector 306 comprises a terminal 312 (FIG. 3C) that is accessible only through an opening 314 in the insulating cover. The terminal 312 provides electrical connection to the electrochemical cells of the battery module 300. For example, a blade of an electrical interconnect can extend through the opening 314 and contact the terminal 312. Here, the opening 314 is substantially a planar rectangle defined by the insulating cover 308. For example, the opening 314 faces along the side surface 304.

The connector 306 can provide advantages in the manufacturing, maintenance, and/or service of the modular high-voltage battery system. In some implementations, the connector 306 ensures that the battery module 300 qualifies for a favorable ingress protection (IP) rating according to International Electrotechnical Commission (IEC) standard IEC 60529 regarding solid particle protection. The battery module 300 can have an IP rating of 2 or higher regarding solid particle protection. For example, the battery module 300 can have an IP rating of 3 or 4. In some implementations, a smallest size of the opening 314 can ensure that a person's finger does not touch the terminal 312. For example, the connector 306 can protect against fingers or other objects not greater than about 80 mm in length. As another example, the connector 306 can protect against fingers or other objects greater than about 12 mm in diameter. Other approaches can be used.

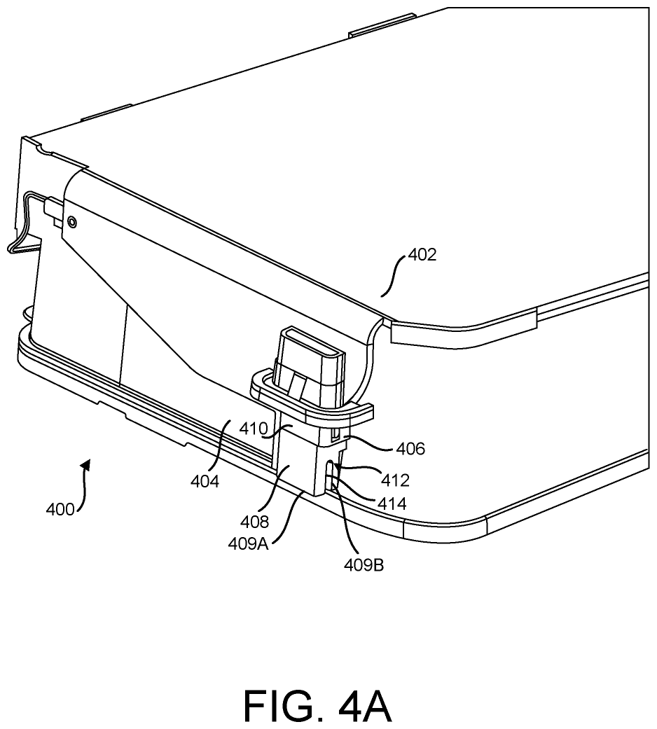

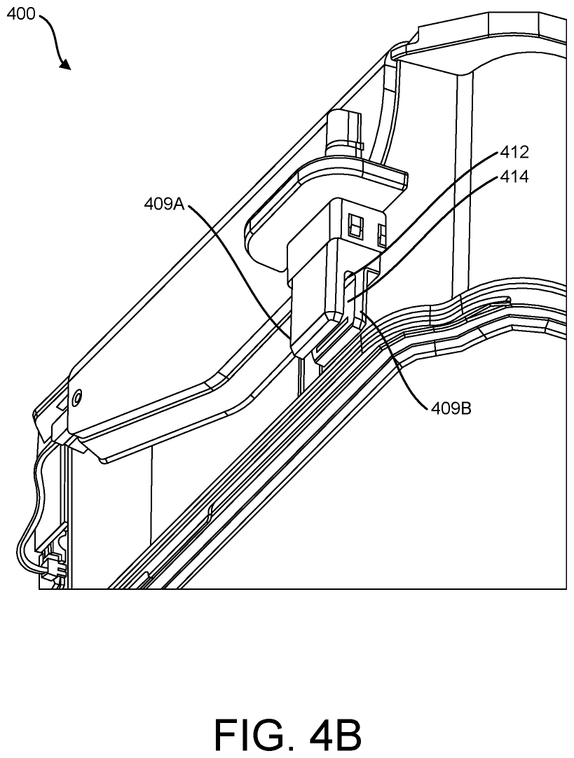

FIGS. 4A-4B show examples of another battery module 400. The battery module 400 can be part of a modular high-voltage battery system and can be used with one or more other examples described elsewhere herein. The battery module 400 includes a housing of an insulating material and encloses electrochemical cells. Here, a main surface 402 and a side surface 404 are shown. The battery module 400 has a connector 406 on the side surface 404. The connector 406 is electrically connected to the electrochemical cells. The connector 406 comprises an insulating cover 408 that includes one or more insulated portions 410. For example, the insulating cover 408 can be made from the same material as the housing of the battery module 400. The connector 406 comprises a terminal 412 that is accessible only through an opening 414 in the insulating cover. The terminal 412 provides electrical connection to the electrochemical cells of the battery module 400. For example, a blade of an electrical interconnect can extend through the opening 414 and contact the terminal 412. The insulating cover 408 includes a member 409A and a member 409B. The members 409A-409B are joined to each other at an end near the terminal 412. The members 409A-409B are separate from each other at their respective free ends that are each opposite from (distal to) the joined ends. That is, the terminal 412 is positioned between the members 409A-409B at the joined end. Here, the opening 414 comprises a gap between the members 409A-409B. The opening 414 is substantially U-shaped (with the terminal 412 positioned substantially at the open end of the U) and defined by the members 409A-409B.

The connector 406 can provide advantages in the manufacturing, maintenance, and/or service of the modular high-voltage battery system. In some implementations, the connector 406 ensures that the battery module 300 qualifies for a favorable IP rating according to the standard IEC 60529 regarding solid particle protection. The battery module 400 can have an IP rating of 2 or higher regarding solid particle protection. For example, the battery module 400 can have an IP rating of 3 or 4. In some implementations, a smallest size of the opening 414 can ensure that a person's finger does not touch the terminal 412. For example, the connector 406 can protect against fingers or other objects not greater than about 80 mm in length. As another example, the connector 406 can protect against fingers or other objects greater than about 12 mm in diameter. Other approaches can be used.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A battery module for a modular high-voltage battery system, the battery module comprising:
electrochemical cells;
a housing of an electrically insulating material, the housing enclosing the electrochemical cells; and
a first connector at an outside surface of the housing, the first connector electrically connected to the electrochemical cells, the first connector comprising an insulating cover and a terminal accessible only through an opening in the insulating cover, the first connector configured for mating with a first electrical interconnect having a busbar to extend into the opening and contact the terminal.

2. The battery module of claim 1, wherein the battery module qualifies for an ingress protection rating according to International Electrotechnical Commission (IEC) standard IEC 60529 regarding solid particle protection of 2 or higher.

3. The battery module of claim 1, wherein the first connector protects against fingers or other objects not greater than about 80 mm in length.

4. The battery module of claim 1, wherein the first connector protects against fingers or other objects greater than about 12 mm in diameter.

5. The battery module of claim 1, wherein the opening is substantially a planar rectangle.

6. The battery module of claim 1, wherein the opening comprises a gap between first and second members, the first and second members joined to each other at a first end and separate from each other at a second end opposite the first end, wherein the terminal is positioned between the first and second members at the first end.

7. The battery module of claim 6, where the gap is substantially U-shaped.

8. The battery module of claim 1, wherein the battery module has substantially a rectilinear shape.

9. The battery module of claim 8, wherein the rectilinear shape comprises first and second main surfaces that are parallel to each other, and four side surfaces that are perpendicular to the first and second main surfaces, wherein each of the side surfaces abuts respective edges of the first and second main surfaces.

10. The battery module of claim 9, wherein the first connector is positioned on at least a first side surface of the side surfaces.

11. The battery module of claim 10, wherein the first side surface is smaller than a second side surface of the side surfaces.

12. The battery module of claim 10, further comprising a second connector configured for mating with a second electrical interconnect, the second connector positioned at the outside surface of the housing on a second side surface of the side surfaces, the second side surface opposite to the first side surface.

13. The battery module of claim 10, wherein the opening faces along the first side surface.

14. The battery module of claim 10, wherein the battery module is configured for being installed side by side with other battery modules with the first side surface of the battery module and corresponding side surfaces of the other battery modules facing in a common direction with each other.

15. The battery module of claim 9, wherein at least the first main surface covers a current collector coupled to at least some of the electrochemical cells.

16. The battery module of claim 1, wherein the first connector is configured for mating with the first electrical interconnect where the busbar is a blade to extend into the opening.

17. A modular high-voltage battery system comprising:
first and second battery modules, each of the first and second battery modules comprising:
electrochemical cells;
a housing of a first electrically insulating material, the housing enclosing the electrochemical cells; and
a connector at an outside surface of the housing, the connector electrically connected to the electrochemical cells, the connector comprising an insulating cover and a terminal accessible only through an opening in the insulating cover; and
an electrical interconnect connecting the first and second modules to each other, the electrical interconnect comprising:
a busbar configured for extending into each of the openings of the connectors of the first and second modules and contact the terminals of the connectors of the first and second modules; and
a second insulating material partially covering the busbar.
